(19) United States
(12) Patent Application Publication
(10) Pub. No.: US 2026/0031374 A1
(43) Pub. Date: Jan. 29, 2026

(54) VOLTAGE MONITORING ARRANGEMENT FOR AN ELECTRIC CELL STACK, PARTICULARLY FOR A FUEL CELL STACK

(71) Applicant: POWERCELL SWEDEN AB, 418 43 Gothenburg (SE)

(72) Inventors: Stefan MUNTHE, Västra Frölunda (SE); Robin VELÈN, Hovas (SE); Johan FLINK, Göteborg (SE)

(73) Assignee: POWERCELL SWEDEN AB, 418 43 Gothenburg (SE)

(21) Appl. No.: 18/994,295

(22) PCT Filed: Jul. 5, 2023
(86) PCT No.: PCT/SE2023/050702

§ 371 Date: Jan. 14, 2025

(30) Foreign Application Priority Data
Jul. 18, 2022 (SE) 2250917-8

(51) Int. Cl. H01M 8/04537; H01M 8/04664

(52) U.S. Cl. CPC H01M 8/04559; H01M 8/04679

(57) ABSTRACT

A voltage monitoring arrangement is provided for an electric cell stack including a plurality of electric plates sandwiching insulation layers, wherein the voltage monitoring arrangement is configured to monitor a voltage of at least one electric plate of the electric cell stack, wherein the voltage monitoring arrangement includes at least one voltage monitoring unit with a contact element being in contact with the at least one electric plate, a first signal line being configured to supply a first signal from a signal source to a processing unit, wherein the voltage monitoring unit includes a first signal path interrupting element interposed in the first signal line, wherein the first signal path interrupting element is connected to the contact element and is configured to forward the first signal dependent on a voltage being present at the at least one electric plate, wherein the voltage monitoring arrangement includes a support element being designed to be arranged within the electric cell stack, wherein the support element is configured to support at least the contact element.

### BACKGROUND AND SUMMARY

The present invention relates to a voltage monitoring arrangement for an electric cell stack, particularly for a fuel cell stack.

Usually, an electric cell stack comprises a plurality of stacked electric plates which are separated from each other by insulating layers. In the special case of a fuel cell stack, the electric plates are bipolar plates, and the insulating layers are multi-layer membrane electrode assemblies. The bipolar plates themselves are a combination of an anode plate and a cathode plate which are fixed to each other, wherein adjacent bipolar plates are then separated, or with other words sandwiched, by the membrane electrode assemblies. The cathode and anodes plate which form the bipolar plates are usually electrically conducting metal or graphite plates, so called flow field plates, having a flow field for the reactants at one side and a flow field for a cooling fluid on the other side. In the assembled state of the membrane electrode assembly, the flow field plates are placed on top of each other in such a way that the cooling fluid flow fields are facing each other, and the reactant fluid flow fields face the sandwiching membrane electrode assemblies. The electric current produced by the membrane electrode assemblies during operation of the fuel cell stack results in a voltage potential difference between the bipolar plate assemblies.

During the operation of the electric stack, the voltage produced by the stacked cells needs to be monitored for determining whether the stack is operating within its intended operation parameters. For that, the electric plates are usually equipped with voltage monitoring units, which are fixed to the electric plate and are provided with wires for connecting the voltage monitoring units to an external voltage monitoring controller, which monitors and controls the operation of the stack.

Thereby, it is known to use the wires as the voltage monitoring units, by soldering or welding the wires directly to the electric plate. In the field of fuel cell stacks, it is also known to use pin connections, where the pins are inserted between the plates of the bipolar plates, where they are fixed by friction force or press fit.

However, placing and fixing the wires into the electric cell stack is cumbersome and time-consuming, which makes the stacking process inefficient and slow. Additionally, the known fixation methods are also prone to failure as the wires and pins may come loose from the plates or the wires and pins are misplaced so that they cause failures in the stack. Additionally, due to the usually tight stacking of the electric plates and associated insulating layer, the electric cell stack lacks the space to fit voltage monitoring units, which might be easier to mount.

Further, the voltage of the electric cell stack may be monitored by measuring the voltage of each electric plate and comparing each measured voltage with a reference or threshold voltage. Alternatively, the voltages within a fuel cell stack may be measured by measuring the voltage of one plate in comparison with the voltage of the previous plate and by monitoring the differences. In any case, a measurement of the voltage of each plate is necessary and requires corresponding measurement means which are cost intensive.

It is therefore desirable to provide a voltage monitoring arrangement which is cost-efficient, and which can easily be implemented into the electric cell stack, and in particular in the fuel cell stack, in a more efficient and reliable way.

The voltage monitoring arrangement is configured to monitor a voltage of at least one electric plate of an electric cell stack. Such an electric cell stack may particularly be a fuel cell stack and may comprise a plurality of electric plates sandwiching insulation layers.

It should be noted that in general, in this application, the term “electric plate” does not necessarily refer to a rigid electric plate. Also, a flexible layer-like electric element (anode or cathode) may be named as electric plate in this application.

Additionally, the electric cell stack may be a fuel cell stack, wherein the electric plate is a bipolar plate consisting of or comprising an anode plate and a cathode plate, which are fixed to each other. Further in that case, the insulating layers are multilayer membrane electrode assemblies. The bipolar plates are usually rigid metal or graphite plates which are provided with flow field structures for providing and distributing reactant and/or coolant to the bipolar plate and/or to the adjacent membrane electrode assemblies.

The voltage monitoring arrangement comprises at least one voltage monitoring unit with a contact element. The contact element is connected to the at least one of the plurality of electric plates for example in the form of a pin or any other kind of connector. In a preferred embodiment as described below, there is more than one voltage monitoring unit, each having a contact element, wherein each of the contact elements is connected to one of the plurality of electric plates. Thereby, the contact element is preferably arranged at a surface of the support element in such a way that the contact element is in electrical contact with the electric plate.

For monitoring the voltage of the electric cell stack, the voltage monitoring arrangement comprises a first signal line being configured to supply a first signal from a signal source to a processing unit, wherein the voltage monitoring unit comprises a first signal path interrupting element interposed in the first signal line, wherein the first signal path interrupting element is connected to the contact element and is configured to forward the first signal dependent on a voltage being present at the electric plate.

Thus, instead of directly measuring and monitoring the voltage of the electric plate, the herein proposed voltage monitoring arrangement uses an indirect monitoring approach. A first signal is transmitted on the first signal line to the processing unit. The first signal itself is applied to the first signal line independent on the voltages of the electric plates. For example, the first signal on the first signal line may originate from an optical or electrical source, like a current or voltage source.

Alternatively, the signal source may be a first electric plate of the plurality of electric plates. This means that the first signal may originate from the first electric plate and may be supplied to the first signal line and then serves as the first signal on the signal line. The transmission on the first signal line may then be interrupted or the first signal may be forwarded using further voltage monitoring units and corresponding signal path interrupting elements of further electric plates as will be described in the following.

The transmission of the first signal on the first signal line however depends on the voltages of the electric plates as will be described in the following: A voltage of the at least one electric plate is tapped by the contact element and transmitted to the first signal path interrupting element. The first signal path interrupting element will then close, i.e., connect through, or open, i.e., interrupt, the first signal line dependent on the tapped voltage of the at least one electric plate. Alternatively, the first signal path interrupting element may open for forwarding the signal on the first signal line and close for interrupting the first signal line dependent on the tapped voltage of the at least one electric plate. When the first signal path interrupting element closes the first signal line, the first signal will be forwarded to the processing unit. When the first signal path interrupting element opens, i.e., interrupts the first signal line, the first signal will not be forwarded to the processing unit.

In the processing unit, it may then only be monitored whether the first signal is received or not. If the processing unit does not receive any signal, there is no voltage present at the at least one electric plate, or the voltage is too low, and this may be interpreted as an electric plate which is not performing as intended, i.e., not operating within its intended operation parameters. Alternatively, depending on the implementation of the signal path interrupting element as described above, if the processing unit receives a signal, there might be no voltage present at the at least one electric plate, or the voltage might be too low, and this may be interpreted as an electric plate which is not performing as intended. For example, this may be the case inter alia if the electric plate is defective. Thus, the proposed voltage monitoring arrangement provides an easy and cost-efficient way of monitoring the voltage of an electric plate, without the need of an actual measuring of the electric plate voltage.

Alternatively, depending on the implementation of the signal path interrupting element as described above, if the processing unit receives a signal, there might be no voltage present at the at least one electric plate, or the voltage might be too low, and this may be interpreted as an electric plate which is not performing as intended. Thus, the signal path interrupting element in combination with the signal line may forward the signal on the first signal line if the electric plate operates as intended and may not forward the signal (i.e., interrupt the signal line) if the electric plate operates not as intended. Or, vice versa, the signal path interrupting element in combination with the signal line may not forward the signal on the first signal line, i.e., interrupt the signal line, if the electric plate operates as intended, and forward a signal if the electric plate operates not as intended. Thus, in the first exemplary implementation, the processing unit may determine that the electric plate is not performing as intended when no signal is received and, in the second exemplary implementation, the processing unit may determine that that electric plate is not performing as intended when a signal is received. It should be noted that in the following, both implementations may be equivalently used and, when only one possible implementation is described, the same features and examples apply also to the other implementation.

For providing a contact between the contact element and the electric plate, the voltage monitoring arrangement comprises a support element. The support element is designed to be arranged within the electric cell stack and is configured to support at least the contact element. The support element may be molded, for example injection molded. The contact element may be molded, preferably injection molded, together with the support element or may be attached afterwards to the support element.

The support element may be made of an electrically isolating material, preferably a plastic material, and the contact element may be made from an electrical conducting material. Thereby a metal such as copper, aluminum, silver, gold, tin, or the like is preferred. When deciding for a certain material for the contact element, the material of the electric plate should be taken into account for avoiding creating galvanic issues. For a stainless-steel electric plate, e.g., a coated copper material such as a gold-plated copper, is preferred. Further, the contact element may be a resilient element, preferably the contact element may be resiliently shaped. For example, the contact element may be shaped as a spring.

According to a further embodiment, the processing unit is configured to output a warning signal if the first signal is not forwarded to the processing unit. As already described above, the processing unit may determine that at least one of the electric plates is not performing as intended if the processing unit does not receive the first signal. In this case, the processing unit may output a warning signal indicating that at least one electric plate is not performing as intended. Alternatively, the processing unit may output a warning signal when the first signal is received, as described above.

When the electric cell stack comprises two or more electric plates according to a further embodiment, the voltage monitoring arrangement comprises a plurality of voltage monitoring units, each of which comprises a contact element being in contact with one of the plurality of electric plates. Further, each voltage monitoring unit comprises a first signal path interrupting element interposed in the first signal line, which is connected to the contact element and is configured to forward the first signal dependent on a voltage being present at the respective electric plate. The first signal path interrupting elements of all voltage monitoring units are connected in series. Thus, if one of the electric plates is not performing as intended, the voltage generated by the electric plate which is not performing as intended will be below the above-mentioned reference threshold voltage and the corresponding first signal path interrupting element will interrupt the first signal line and no first signal will be received at the processing unit. Vice versa, the first signal path interrupting elements will connect the first signal through when the voltage generated by the respective electric plate is above the reference threshold voltage. In this case, the processing unit will receive the first signal. As described above, the interruption and forwarding of the signal transmission may also be reversed, i.e., a signal may be forwarded if the electric plate does not perform as intended and no signal may be forward if the electric plate performs as intended.

Thus, instead of monitoring the exact voltage of each electric plate, it is sufficient to monitor the voltages of the electric plate in a more abstract manner. As it is necessary to disassemble the complete electrical cell stack when one of the electric plates is not performing as intended, it is sufficient to monitor the voltages of all electric plates as a whole. When one of the electric plates is not performing as intended, the first signal is not forwarded to the processing unit (or alternatively the first signal is forwarded as described above) and the processing unit thus determines that at least one electric plate is not performing as intended, which means that the whole stack is not performing as intended, although it is not known which electric plate is not performing as intended. In this case, the whole electrical cell stack may be disassembled and then, each electric plate may be checked regarding its functionality. Thus, the herein described voltage monitoring arrangement provides an easy and cost-efficient way of monitoring the electrical cell stack. Alternatively, before disassembling the whole electrical cell stack, an additional evaluation unit may be installed for evaluating each electric plate separately. For example, such an evaluation unit may be attached to each electric plate for further inspection.

In another embodiment, only some of the voltage monitoring units, i.e., a subgroup of the voltage monitoring units, comprise a signal path interrupting element. According to this embodiment, some of the voltage monitoring units only comprise a contact element for tapping the voltage of the corresponding electric plate. The tapped voltages of several consecutive electric plates are transmitted to the respective one of the voltage monitoring units which comprises a signal path interrupting element. This voltage monitoring unit switches the signal path interrupting element based on an accumulated total voltage of the preceding electric plates. Thus, instead of interrupting the first signal line when the voltage of the corresponding electric plate is below the defined threshold, the voltage monitoring unit interrupts the first signal line when the accumulated total voltage of the preceding electric plates is below a predefined threshold. Alternatively, the voltage monitoring unit may forward the signal on the first signal line when the accumulated total voltage of the preceding electric plates is below a predefined threshold.

For example, each fifth voltage monitoring unit comprises a signal path interrupting element, which may be arranged within the corresponding support element. The first to fourth voltage monitoring unit taps the voltage of the corresponding electric plates and forwards the tapped voltage to the fifth voltage monitoring unit. The fifth voltage monitoring unit switches the signal path interrupting element when the accumulated voltage of the first to fourth and fifth electric plate is below or above the predefined threshold, as described above.

According to a further embodiment, the support element has a base plate. In case the electric plate has at least one protruding structure, e.g. a bead seal or flow field, which protrudes from the basis of the electric plate in direction of the adjacent insulating layer, it is further that a height h_{b} of the base plate of the support element is designed to resemble, preferably to be less than, a protruding height hₛₑₐₗ of the protruding structure over the basis of the electric plate: h_{b}≈hₛₑₐₗ, preferably h_{b}<hₛₑₐₗ. This ensures that the support element can be placed within the electric cell stack without further space requirement. Further, this has the advantage that the height of the base plate of the support element does not affect the sealing properties of the bead seal and allows to implement the support element and thus also the other elements of the voltage monitoring arrangement within the electric cell stack without increasing the size of the electric cell stack.

The first signal path interrupting element may be arranged either within the electric cell stack, for example arranged at the support element, or may be arranged outside of the electric cell stack. The same applies to the first signal line and the processing unit, as described in further detail below.

According to an embodiment, the first signal path interrupting element is configured to forward or to interrupt the first signal, when the voltage being present at the at least one electric plate is above a reference threshold voltage. Vice versa, when the voltage being present at the at least one electric plate is below the reference threshold voltage, the first signal path interrupting element may be configured to interrupt a signal transmission on the first signal line or to forward the signal. The reference threshold voltage may be a voltage which is considered to delimit a normal operating voltage or voltage range of the at least one electric plate from a voltage being indicative for a defect or a performance of the at least one electric plate being not as intended.

According to a further embodiment, the first signal is an electrical signal, and the first signal path interrupting element is a relay, electrical switch, or electro-mechanical switch. The electrical signal may be a voltage or current signal which can be received in the processing unit. The first signal path interrupting element may be any kind of switch-like element which is able to interrupt a signal transmission of the first signal on the first signal line or to direct the first signal through. For example, the signal path interrupting element may be a relay, for example, in the form of a transistor, in particular a bipolar transistor. The relay may be operated or switched by the voltage being present at the electric plate. For example, in case the relay is a transistor, the voltage at the electric plate may be applied to the base of the transistor and the transistor may then connect through, particularly when the voltage on the at least one electric plate is above the reference threshold. Subsequently, the first signal is transmitted through the transistor in the first signal line and forwarded to the processing unit.

According to an alternative embodiment, the first signal may be an optical signal and the signal path interrupting element may be an electrical or electro-mechanical switch, for example a piezo element. In this case, the first signal line may be an optical fiber or the like transmitting an optical signal and the signal path interrupting element may be configured to interrupt the propagation of the optical signal on the first signal line. For example, when using a piezo element, which is an electro-mechanical switch being activated by a voltage, the piezo element may be influenced by a voltage being present or being absent (depending on the actual implementation) and may then open or close the optical path.

According to a further embodiment, the support element is made from an electrically insulating material and is equipped with the contact element made from an electrically conducting material, which is arranged at a surface of the support element, and which is adapted to be in contact with the electric plate. The known pins or wires are quite small so that fixing the voltage monitoring units to the plates is a very delicate work. Further, there is a high risk of misplacing the pins, which can result in a damage of the stack element and eventually in a failure of the whole stack. By providing a support element which is mainly made from an electrically insulating material and is only at special locations equipped with electrically conducting elements allows for a simpler and simplified handling and mounting of the support element including the contact element.

In addition, the support element may also be equipped with the voltage monitoring unit, in particular the first signal path interrupting element or further elements being part of the voltage monitoring unit. The voltage monitoring unit may either be incorporated, e.g., molded, into the support element during manufacturing of the support element or may be attached to a surface of the support element. Further, a wire or the like may be integrated into the support element for providing a contact between the contact element and the first signal path interrupting element and/or the first signal line and/or the processing unit.

In order to implement the support element more efficiently, said at least electric plate at which the support element is arranged has at least one through hole, wherein at and/or in the through hole the support element is arranged. Thereby, the through hole provides an additional space which allows for accommodating the support element and/or the voltage monitoring unit.

According to a further preferred embodiment, the support element has a base plate and a protruding portion, wherein the protruding portion is recessed from the base plate so that a step is formed between the base plate and the protruding portion. Thereby, it is advantageous that an overall height H_{VM} of the support element is designed to be less than a height of the protruding portion of the electric plate: h<h_{SEAL}. Such a support element does not require any additional space as it is at least partly fully accommodated in the electric plate.

Preferably, the protruding portion of the support element may be received within the through hole of the electric plate. Thereby, an easy-to-handle element is provided which can be arranged at the electric plate and in the through hole in a time efficient way. Further, the protruding portion may be used for receiving the first signal path interrupting element and/or may be used for receiving the first signal line.

It is further preferred that a height hₚ of the protruding portion of the support element is designed to be less than a thickness H_{BPP} of the electric plate: hₚ<H_{BPP}. This allows for a support element that is flush with the electric plate on at least one side. Such a support element does not require any additional space as it is at least partly fully accommodated in the electric plate.

According to a further embodiment, the support element is adapted to be stacked on a further support element. For electrically connecting two stacked support elements, the support element may comprise pins which electrically connect to the further support element. Such pins may particularly be useful when the first signal line and/or the first signal path interrupting element is arranged within the electric cell stack, for example within the support element, and need to be conducted across the transition between the two support elements. Additionally or alternatively, the support element may comprise through holes being configured to accommodate cables and/or to transmit light, in particular for providing a connection across the two support elements.

According to a further advantageous embodiment, the support element has, at the opposite side of the protruding portion, at the base plate a recess which is dimensioned to accommodate the protruding portion of an adjacent support element, so that one support element is adapted to be stacked on a further support element. Thereby, even if the support element is extending over the electric plate, e.g., after compression of the stack, the exceeding part does not negatively interfere with the overall dimensions of the stack.

To the contrary, in case such a recess is provided, it might also be possible to provide a support element, wherein a height hₚ of the protruding portion of the support element is designed to be greater than a thickness H_{BPP} of the electric plate: hₚ>H_{BPP}, and wherein a depth hᵣ of the recess is adapted to accommodate that part of the protruding portion of the support element which extends over the electric plate. Thereby, the support element can also be used as alignment feature for the components of the stack, as the stacked support elements also define a certain orientation of the electric cell stack components to each other.

According to a further preferred embodiment, a diameter of the base plate is designed to be larger than a diameter of the through hole so that a surface of the step at least partially abuts a surface of the electric plate, and the protruding portion extends through the through hole of the electric plate. This allows for a secure mounting of the support element at and in the through hole of the electric plate.

It is further preferred if the support element further comprises a cover portion, wherein a diameter of the cover portion is larger than a diameter of the through hole so that the support element is fixed to the electric plate. This allows for a connection and fixation of the cover element on both sides of the plates. The cover element could be for example realized as snapping elements which extend over the rim of the electric plate after having been inserted through the through hole, so that the support element is fixed to the electric plate.

Alternatively of additionally, the cover portion may be a separate element which is adapted to interact with the protruding portion of the support element for fixing the support element to the electric plate. Thereby, it is particularly preferred that the cover element has a recess which is designed to accommodate the protruding portion in such a way that a connection between cover element is provided by form fit or force fit. E.g., the cover element can be pressed and/or clicked onto the protruding portion.

For also providing the signal interrupting path features and/or the internal alignment feature, it is possible that the cover element further comprises a protrusion on the opposite side to its side facing the electric plate, which allows for an interaction with an adjacent support element, particularly for an interaction with the recess of the adjacent support element. It is further possible that the cover element has an annular form which interacts with the protruding portion in a friction fit manner, so that the protruding portion may extend through the annular cover element and be accommodated in the recess of the adjacent support element.

The cover element thereby ensures that the support element remains fixed to the electric plate even if the electric plate is not arranged in the stack. This also allows for pre-mounting of the support element at the electric plate before stacking.

Such a cover element may also be used for accommodating the voltage monitoring unit, particularly the first signal path interrupting element. In this case, a wire connecting the contact element with the first signal path interrupting element, may be arranged within the base plate and the protruding portion, wherein further the protruding portion may be equipped with pins or the like for providing an electrical connection between the wire and the first signal path interrupting element, i.e., between the contact element and the first signal path interrupting element.

In case the electric plate has at least one protruding structure, e.g. a bead seal or flow field, which protrudes from the basis of the electric plate in direction of the adjacent insulating layer, it is further preferred that also a height h_{c} of the cover portion of the support element is designed to resemble, preferably to be less than, a protruding height hₛₑₐₗ of the protruding structure over the basis of the electric plate: h_{c}≈hₛₑₐₗ, preferably h_{c}<hₛₑₐₗ. This also ensures that the support element and the other elements of the voltage monitoring arrangement can be placed within the electric cell stack without further space requirement and without increasing the size of the electric cell stack.

According to a further preferred embodiment, the protruding portion of the support element may have a first part and a second part, wherein the second part is recessed to the first part, thereby forming a further step between the first and the second part of the protruding portion, and wherein the further step is provided with an contact element which is adapted to contact an electric plate. Thereby it is further preferred that both steps, the step between base plate and first part and the step between first and second part are equipped with contact elements. This allows for electrically connecting not only a single electric plate but two electric plates which are arranged adjacent to each other, which further reduces the time requirements during stacking and simplifies the stacking process as only every third plate needs to be equipped with a separate support element. Such an arrangement may particularly preferred when one signal path interrupting element connects to more than one contact element, i.e., is responsible for the sensed voltages of more than one electric plate as will be described below in further detail.

According to a further preferred embodiment, the contact element is arranged at a surface of the support element. Preferably, the contact element is arranged at the base plate, preferably at the step, and/or at the protruding portion and/or at the cover portion in such a way that the contact element is in contact with the electric plate.

According to a further preferred embodiment, the electric cell stack has at least two, preferably three, electric plates which are stacked, wherein the heights hₚ₁, hₚ₂ of the first and second parts are designed such that the contact element which is arranged at the first step is in contact with the first electric plate, and the contact element which is arranged at the further step between the first and the second part is in contact with the second electric plate. Further, the second part may protrude into an opening in the second electric plate but does not exceed over the second electric plate. Alternatively, the second part exceeds over the second electric plate and may be adapted to be accommodated in a recess of an adjacent support element being arranged at the third bipolar plate. This allows to implement the support element within the electric cell stack without increasing the size of the electric cell stack. It goes without saying that the support element may have a plurality of further steps, wherein each step is equipped with an electric connector to be in contact with a respective electric plate.

It may be further preferred that the electric plate has a first and a second through hole at and/in which a support element is accommodated, wherein a size and/or shape of the first and second through hole differ from each other. This allows, in particular, for an advantageous interaction between the stepped support element and the two adjacent electric plates. Thereby it is further advantageous if the size of the first part of the protruding portion is adapted to the size and/or shape of the first through hole and the size of the second part of the protruding portion is adapted to the size and/or shape of the second through hole. This allows for a fail-safe arrangement of support element and through holes/electric plates.

It is further preferred that adjacent electric plates and corresponding first and second through holes are arranged in such a way that the first through hole of one electric plate is aligned with the second through hole of the adjacent electric plate. Thereby, it is further preferred, if the electric plates are symmetric concerning a rotation of 180° around the surface normal of the electric plate. In case the electric plate is a bipolar plate it is preferred that the bipolar plates are symmetrical concerning a rotation of 180° around the surface normal of the cathode or anode side. Thereby, rotation of each second electric plate of the stack by 180° results in an automatic arrangement of alternating first and second through holes. Besides a simplified manufacturing, stacking and alignment, as only one set of electric plates has to be produced, this allows also for compensating manufacturing tolerances, which would lead to an uneven size of the stack.

According to a further embodiment, the voltage monitoring unit further comprises a voltage fluctuation levelling element being arranged between the contact element and the first signal path interrupting element and being configured to transmit the voltage from the contact element to the first signal path interrupting element when the voltage is above a levelling threshold voltage. Such a voltage fluctuation levelling element may be implemented for example using a resistor or any kind of filtering element being able to equalize voltage fluctuations. The voltage fluctuation levelling element may be used for eliminating voltage fluctuations, i.e., to level out the voltage fluctuations. Such fluctuations may cause that the first signal path interrupting element very often switches between its two different stages, although the voltage does not change much but only within a small range, e.g., caused by typical fluctuations without a deterioration of the at least one electric plate. When such a voltage fluctuation levelling element is used, it may be avoided that the first signal path interrupting element switches between its two stages without being caused by a deterioration of the at least one electric plate. As unnecessary switching of the first signal path interrupting element may be reduced by the voltage fluctuation levelling element, the first signal path interrupting element may also be protected as voltage fluctuations may be filtered and does not influence the signal path interrupting element being downstream of the voltage fluctuation levelling element. Reduced switching of the signal path interrupting element may increase the lifetime of the signal path interrupting element.

According to a further embodiment, the voltage monitoring unit, i.e., the combination of voltage fluctuation levelling element and signal path interrupting element, may be used for defining the reference threshold voltage, below which the electric plate may be considered as not performing as intended. This means, that, when the at least one electric plate generates a voltage below such a reference threshold voltage, the signal path interrupting element may interrupt the signal transmission on the signal line or, alternatively, may forward the signal on the signal line.

As already described above, further elements of the voltage monitoring arrangement and particularly the voltage monitoring unit, e.g., the voltage fluctuation levelling element, may also be arranged within the electric cell stack. Alternatively, only some of the elements may be arranged within or at the support element and some may be arranged outside of the support element or even outside of the electric cell stack. For example, the voltage monitoring unit including the contact element, the signal path interrupting element and the voltage fluctuation levelling element may be arranged within or at the support element, whereas the signal line and the processing unit may be arranged outside of the support element or even outside of the electric cell stack. Further, also the signal line may be arranged within or at the support element and in particular may be guided through the support element(s).

According to a further embodiment, two support elements supporting contact elements, which contact two adjacent electric plates, are arranged at different ends of the electric cell stack. This may provide inter alia the advantage that more space is available for each support element as they do not need to be stacked.

According to a further embodiment, the voltage monitoring arrangement comprises a second signal line being connected in parallel with the first signal line. In this embodiment, the voltage monitoring unit comprises a second signal path interrupting element being interposed in the second signal line and being connected in parallel with the first signal path interrupting element. The first and the second signal path interrupting element may be adapted to different threshold voltages so that a more detailed monitoring of the electric plates is realized. The first and the second signal line may either be arranged within the electric cell stack, preferably guided within the support elements, or may be arranged outside of the electric cell stack. Also, one signal line may be arranged within the electric cell stack, and one may be arranged outside of the electric cell stack.

For example, the first signal path interrupting element may be configured to forward (or interrupt) the first signal when the voltage at the electric plate is above a first reference voltage and the second signal path interrupting element may be configured to forward (or interrupt) the second signal when the voltage at the electric plate is above a second reference voltage. Preferably, the first reference voltage and the second reference voltage are different to each other. This provides the advantage that different warning stages may implemented. For example, the first signal path interrupting element may serve as a first warning stage so that the first signal path interrupting element interrupts the transmission of the first signal when the voltage generated by the electric plate drops below a higher reference threshold voltage. This higher reference threshold voltage may indicate that the electrical cell stack is, although still functioning, reaching a critical state. When the generated voltage drops also below the lower reference threshold voltage of the second signal path interrupting element, the processing unit may determine that the electric cell stack needs to be disassembled and at least one of the electric plates needs to be replaced.

The voltage monitoring arrangement may be scalable as needed, for example by a third signal line and a third signal path interrupting element, a fourth signal line and a fourth signal path interrupting element and so on. The more signal lines and corresponding signal path interrupting elements are used, the more different warning stages may be implemented.

It should be noted that in this embodiment, when several voltage monitoring units are used, the first signal path interrupting elements of all voltage monitoring units are connected in series, the second signal path interrupting elements of all voltage monitoring units are connected in series, and so on.

Further preferred embodiments are defined in the dependent claims as well as in the description and the figures. Thereby, elements described or shown in combination with other elements may be present alone or in combination with other elements without departing from the scope of protection.

### BRIEF DESCRIPTION OF THE DRAWINGS

In the following, preferred embodiments of the invention are described in relation to the drawings, wherein the drawings are exemplarily only, and are not intended to limit the scope of protection. The scope of protection is defined by the accompanied claims, only.

The figures show:

FIG. 1: a schematic view of a voltage monitoring arrangement for an electric cell stack according to a first exemplary embodiment;

FIG. 2: a schematic view of a voltage monitoring arrangement for an electric cell stack according to a further exemplary embodiment;

FIG. 3: a schematic view of a voltage monitoring arrangement for an electric cell stack according to a further exemplary embodiment;

FIG. 4: a cross section through a fuel cell stack according to a further exemplary embodiment;

FIG. 5: a cross section through a fuel cell stack according to a further exemplary embodiment;

FIG. 6: a cross section through a fuel cell stack according to a further exemplary embodiment;

FIG. 7: a cross section through a fuel cell stack according to a further exemplary embodiment;

FIG. 8: a cross section through a fuel cell stack according to a further exemplary embodiment;

FIG. 9: a cross section through a fuel cell stack according to a further exemplary embodiment;

FIG. 10: a cross section through a fuel cell stack according to a further exemplary embodiment;

FIG. 11: a cross section through a fuel cell stack according to a further exemplary embodiment;

FIG. 12: a cross section through a fuel cell stack according to a further exemplary embodiment;

FIG. 13: a cross section through a fuel cell stack according to a further exemplary embodiment;

FIG. 14: a schematic top view of a bipolar plate of fuel cell stack according to a further exemplary embodiment,

FIG. 15: a schematic cross section through a part of a fuel cell stack according to a further exemplary embodiment,

FIG. 16: a schematic cross section through a part of a fuel cell stack according to a further exemplary embodiment, und

FIG. 17: a schematic cross section through a part of a fuel cell stack according to a further exemplary embodiment.

### DETAILED DESCRIPTION

In the following same or similar functioning elements are indicated with the same reference numerals.

In the following, the principle of the invention is described for the case of a fuel cell stack, wherein the electric plates are bipolar plates, and the insulation layers are membrane electrode assemblies. However, the principle can be likewise applied to any other kind of electric cell or electric cell stack. Further, features illustrated with regard to one embodiment may also be included alone or in combination in other embodiments.

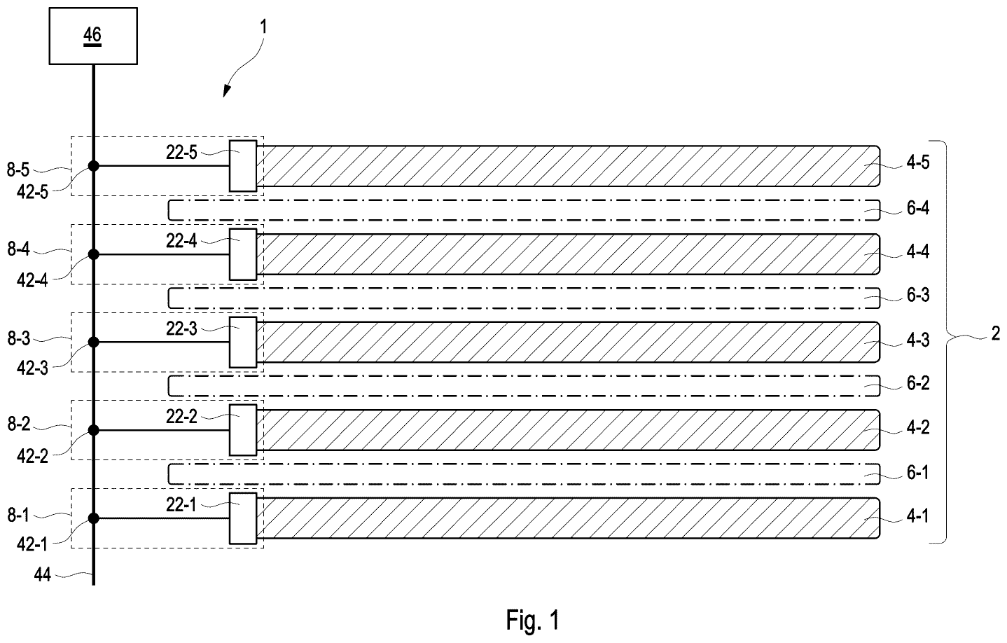

FIG. 1 shows a voltage monitoring arrangement 100 for a fuel cell stack 1. The fuel cell stack 2 comprises a plurality of bipolar plates 4-1 to 4-5 sandwiching membrane electrode assemblies 6-1 to 6-4. The fuel cell stack 2 generates a total voltage as a result of individual voltages of each bipolar plate 4-1 to 4-5. As the bipolar plates 4-1 to 4-5 may wear over time and the generated total voltage depends on each bipolar plate 4-1 to 4-5, it is necessary to monitor the generated voltages.

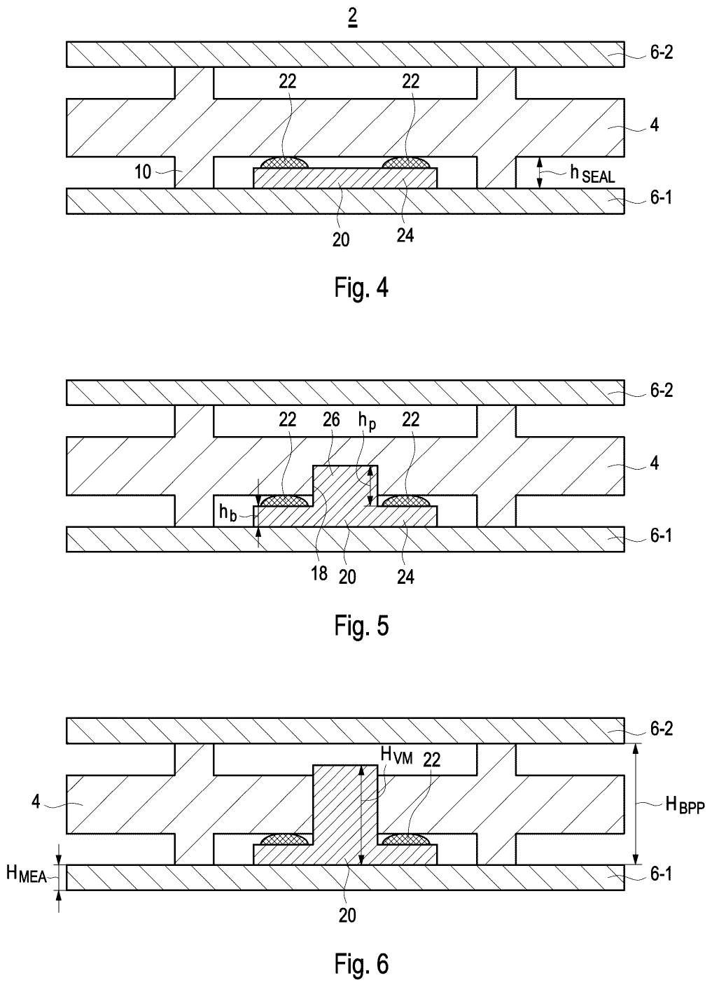

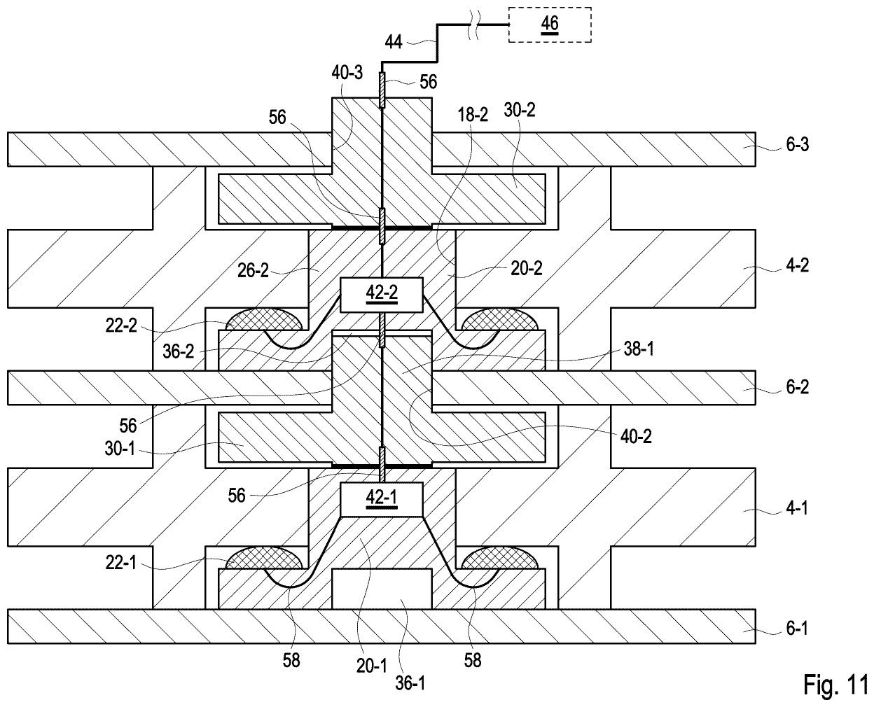

For this purpose, the voltage monitoring arrangement 1 comprises several voltage monitoring units 8-1 to 8-5, preferably one for each bipolar plate 4-1 to 4-5, and several support elements 20 (see for example FIG. 4). Each voltage monitoring unit 8-1 to 8-5 comprises a contact element 22-1 to 22-5. Each support element 20 carries at least one contact element 22-1 to 22-5. Each contact element 22-1 to 22-5 is in contact with one of the plurality of bipolar plates 4-1 to 4-5. Several possibilities of connecting the contact elements 22-1 to 22-5 to the bipolar plates 4-1 to 4-5 are explained below with reference to FIGS. 4 to 17. Via the contact elements 22-1 to 22-5, the respective voltages of the bipolar plates 4-1 to 4-5 are tapped and transmitted to first signal path interrupting elements 42-1 to 42-5. The first signal path interrupting elements 42-1 to 42-5 are interposed in a first signal line 44, which is configured to transmit a first signal to a processing unit 46.

In the following, the signal is an electrical signal, and the signal path interrupting elements are electrical switches, for example transistors. However, it should be noted that the signal may also be an optical signal and the signal path interrupting elements may also be electro-mechanical switches, like piezo elements, or the like. The following description also applies to such an embodiment. Further, in the following, the signal path interrupting elements are configured to interrupt a signal transmission when one electric plate is not performing as intended. However, the following description may analogously be applied to an embodiment where the signal path interrupting elements are configured to forward the signal when an electric plate does not perform as intended and to interrupt the signal transmission when the electric plates perform properly.

The signal may originate from an electric source, for example a voltage supply. Alternatively, the voltage of the first bipolar plate 4-1 may be used as the signal to be transmitted on the signal line 44. The first signal line 44 supplies the first signal to the processing unit 46. The processing unit 46 can determine, based on the received signal, whether the fuel cell stack 2 operates properly, as will be described in further detail in the following.

The first signal path interrupting elements 42-1 to 42-5 receive the respective voltages of the bipolar plates 4-1 to 4-5 via the contact elements 22-1 to 22-5. Dependent on the respective voltage, each of the first signal path interrupting elements 42-1 to 42-5 either forwards the signal on the first signal line 44 or interrupts the transmission. When all generated voltages are sufficient, all first signal path interrupting elements 42-1 to 42-4 forward the signal to the respective next first signal path interrupting element 42-2 to 42-5 and the last one 42-5 of the first signal path interrupting elements forwards the signal to the processing unit 46.

The signal path interrupting elements 42-1 to 42-5 may be realized for example using electrical switches which open when the voltage is below a threshold and close when the voltage is above the threshold. In the first case, the signal line 44 is interrupted, and in the second case, the signal line 44 is closed and the signal may be forward to the respective next signal path interrupting element 42-2 to 42-5. For example, the signal path interrupting elements 42-1 to 42-5 may be transistors, wherein the voltage from the contact elements 22-1 to 22-5 is applied to the bases of the transistors, resulting in a voltage flow from emitter to collector or vice versa— depending on the transistor type—when the applied voltage is above the threshold.

When the voltage of for example the bipolar plate 4-2 drops below a reference threshold voltage, the corresponding first signal path interrupting element 42-2 interrupts the transmission of the signal on the first signal line 44. In this case, although the other first signal path interrupting elements 42-1, 42-3 to 42-5 would still be closed, i.e., would still connect the first signal line 44 though and would therefore still forward the signal, the processing unit 46 does not receive any signal as the first signal line 44 is interrupted by the first signal path interrupting element 42-2. The processing unit 46 may then output a warning signal that at least one of the bipolar plates 4-1 to 4-5 is not performing as intended.

The processing unit 46 cannot determine which bipolar plate 4-1 to 4-5 is not performing as intended but can only determine that any plate is not performing as intended. However, it has been noted that this information is sufficient as in any case, the whole fuel cell stack might need to be disassembled. A further detailed evaluation of the bipolar plates 4-1 to 4-5 can be done after disassembly of the whole stack 2. Alternatively, a further detailed evaluation can be done by installing an additional evaluation unit for evaluating bipolar electric plate separately, prior to a disassembly of the whole fuel cell stack. For example, such an evaluation unit may be attached to each bipolar plate 4-1 to 4-5 for further inspection of the individual bipolar plates 4-1 to 4-5.

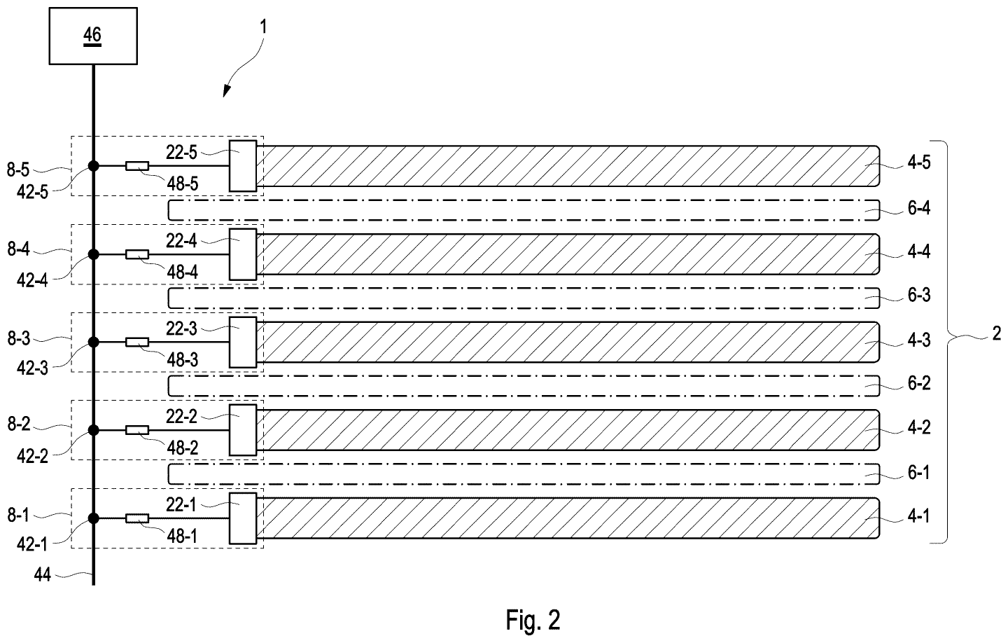

The voltage monitoring arrangement 1 can also comprise voltage fluctuation levelling elements 48-1 to 48-5 for protecting the first signal path interrupting elements 42-1 to 42-5, as shown in FIG. 2. The voltage fluctuation levelling elements 48-1 to 48-5 are connected in series between the contact elements 22-1 to 22-5 and the first signal path interrupting elements 42-1 to 42-5 and are configured to transmit the voltage from the respective contact elements 22-1 to 22-5 to the first signal path interrupting elements 42-1 to 42-5 when the voltage is above a levelling threshold voltage. Thus, voltage fluctuations may be filtered and does not influence the downstream signal path interrupting elements 42-1 to 42-5. The voltage fluctuation levelling elements 48-1 to 48-5 may be for example resistors.

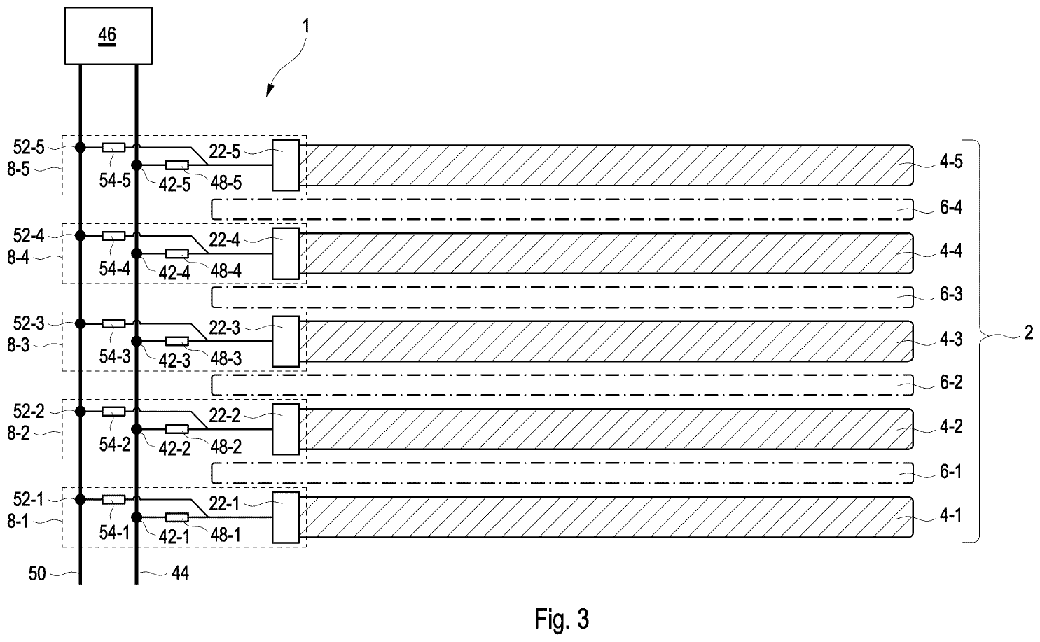

In a further embodiment, as illustrated in FIG. 3, the voltage monitoring arrangement 1 comprises an additional second signal line 50 being connected in parallel to the first signal line 44 and being also connected to the processing unit 46. The signal being transmitted on the first signal line 44 may have the same origin as the signal being transmitted on the second signal line 50 or may have a different origin, for example a voltage source. Each voltage monitoring unit 8-1 to 8-5 comprises a second signal path interrupting element 52-1 to 52-5, which are interposed in the second signal line 50 and are connected in parallel with the respective first signal path interrupting elements 42-1 to 42-5. Preferably, the first and the second signal path interrupting elements 42-1 to 42-5 and 52-1 to 52-5 are adapted to different threshold reference voltages.

As described with reference to FIG. 2, each voltage monitoring unit 8-1 to 8-5 may also comprise a second voltage fluctuation levelling element 54-1 to 54-5, being connected in series between the contact elements 22-1 to 22-5 and the second signal path interrupting elements 52-1 to 52-5. Analogously to the voltage fluctuation levelling elements 48-1 to 48-5, the second voltage fluctuation levelling elements 54-1 to 54-5 also serve as protection for the second signal path interrupting elements 52-1 to 52-5 by filtering voltage fluctuations. It should be noted that the voltage fluctuation levelling elements 48-1 to 48-5 and 54-1 to 54-5 are optional and can also be omitted.

The first and the second signal line 44, 50 may be used to provide a step-line warning system. This means that the first signal line 44 and the second signal line 50 with their corresponding signal path interrupting elements 42-1 to 42-5 and 52-1 to 52-5 are each adapted to a different reference voltage threshold. For example, when the voltage generated by one (e.g., 4-2) of the bipolar plates 4-1 to 4-5 drops below a first reference threshold voltage, the corresponding first signal path interrupting element 42-2 interrupts the transmission of the first signal as the voltage supplied to the first signal path interrupting element 42-2 is below the required first reference threshold voltage. Thus, the signal transmission on the first signal line 44 is interrupted and the processing unit 46 determines that the signal on signal line 50 is received but the signal on signal line 44 is not received. The processing unit 46 may then output a pre-warning signal indicating that one of the bipolar plates 4-1 to 4-5 has reached a critical state but is still functioning.

When the voltage generated by the bipolar plate 4-2 also drops below a second, lower reference threshold voltage, the corresponding second signal path interrupting element 22-2 interrupts the transmission also on the second signal line 50 and the processing unit 46 determines that the fuel cell stack 2 needs to be disassembled and at least one of the bipolar plates 4-1 to 4-5 needs to be replaced.

The voltage monitoring arrangement 1 may comprise more than two signal lines 14, 50 with corresponding signal path interrupting elements and can therefore be upscaled as necessary. Dependent on the number of signal lines, a more detailed monitoring with different warning stages can be implemented.

The contact elements 22-1 to 22-5 are arranged within the fuel cell stack 2. The further elements, i.e., signal path interrupting elements 42, 52, voltage fluctuation levelling elements 48, 54 as well as the signal lines 44, 50, can be arranged within the fuel cell stack 2, in particular in or at a support element 20, or can be arranged outside. Also, some of the elements can be arranged within the fuel cell stack 2, in particular in or at a support element 20, and some of the elements can be arranged outside of the fuel cell stack 2. Several exemplary embodiments for the different arrangements are shown in the following FIGS. 4 to 17.

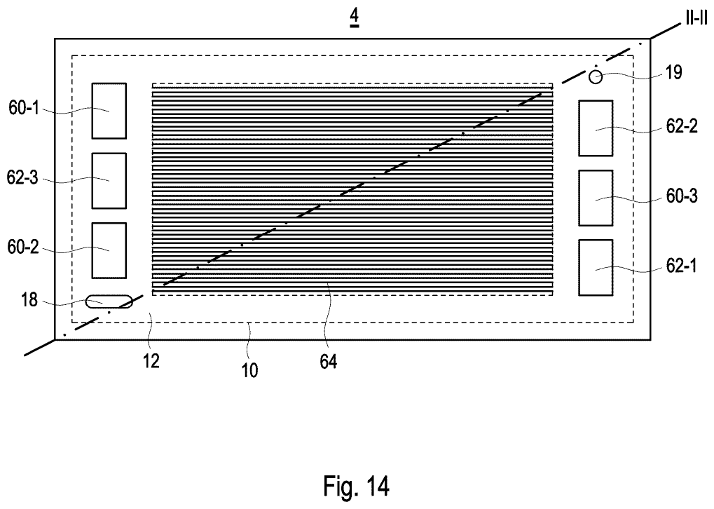

FIGS. 1 to 13 show partly a fuel cell stack 2, with at least one bipolar plate 4. An example of such a bipolar plate is illustrated in FIG. 14, which shows a simplified schematic top view of a bipolar plate 4 of a fuel cell stack 2 according to any of the above exemplary embodiments. Each bipolar plate 4 is usually a combination of an anode plate and a cathode plate which are fixed to each other. Each anode and cathode plate has a front side and a back side, wherein the front or reactant side faces an adjacent membrane electrode assembly (not shown in FIG. 14), and the back or coolant sides faces each other. Further each bipolar plate 4 has a plurality of openings 60, 62, namely manifolds, for providing (openings 60) and discharging (openings 62) reactant and coolant to and from the bipolar plate 4. For distributing the reactant and coolant over the plate the bipolar plates may further have protruding structures (not shown) which form fluid flow fields 64 for the respective reactant/coolant. For sealing the flow fields to the environment, the plates are further equipped with bead seals 10 (see also FIGS. 4 to 13) which protrude from the basis 12 of the plate and may also extend over the height of the flow field structures.

Each bipolar plate 4 is sandwiched by a first membrane electrode assembly 6-1 and second membrane electrode assembly 6-2. The membrane electrode assembly 6, which corresponds to the insulating layers 6 of FIGS. 1 to 3, is usually a multi-layer membrane electrode assembly, but is, for the sake of simplicity, only illustrated as single layer in the Figs. It is further illustrated that the bipolar plates 4 have protruding structures 10, 14, e.g., bead seals or channel like structures of a flow field, which protrude over a basis 12 (anode side), 16 (cathode side) of the bipolar plate 4.

As noted above, in order to carry the contact element 22 of FIGS. 1 to 3, a support element 20 is provided. The FIGS. 1 to 9 show various preferred embodiments of such a support element 20. Each support element 20 is equipped with at least one contact element 22, which is arranged at a surface of the support element 20 and which is adapted to be in contact with the bipolar plate 4. For the sake of simplicity, the contact element 22 is only schematically illustrated in the Figures. It should be noted that each contact element 22 can be equipped with a wire (not shown) for a connection to a corresponding signal line 44, 50 via a corresponding signal path interrupting element 42, 54.

For mounting the support element 20 to the bipolar plate 4, the bipolar plate 4 is provided with through holes 18 into which and through which the support element 22 may be inserted. As can be seen in FIG. 14, the bipolar plate 4 is equipped with two through holes 18, 19, which are diagonally arranged at the bipolar plate 4.

Further, in the illustrated embodiments, the support element 20 is made from an electrically insulting material, whereas the contact element 22 is made from an electrically conducting material. The electrical insulating material may be a plastic material, and the support element 20 may be molded or injection molded. The contact element 22 may be made from copper. Also, the contact element 22 may be a resilient element, preferably the contact element is resiliently shaped 22. For example, the contact element 22 may be shaped as a spring, which is schematically illustrated by the half-circular shape of the contact element in the FIGS. 4 to 13.

In a very simple form as illustrated in FIG. 4, the support element 20 has a base plate 24, at which the contact element 22 is arranged so that the contact element 22 is in contact with the respective bipolar plate 4. As can be further seen from FIG. 4, the height h_{b} of the base plate 24 and the height h_{c} of the contact element 22 is designed so that the overall height h_{b}+h_{c} of the base plate 24 and of the contact element 22 is less than a height h_{SEAL} of the protruding portion 14, e.g. of the bead seal, of the bipolar plate 4: h_{SEAL}>h_{b}+h_{c}.

In further embodiments as illustrated in FIGS. 5 to 13, the support elements 20 have a base plate 24 and a protruding portion 26. The protruding portion 26 is recessed from the base plate 24 so that a step 28 is formed between the base plate 24 and the protruding portion 28. Moreover, the contact element 22 can be either arranged at the base plate 24, and in particular at the step 28, or can be arranged at the protruding portion 28 as described below. In any case, the contact element 22 is in contact with the respective bipolar plate 4.

The height of the protruding portion hₚ of the support element 20 may be designed so that the support element 20 does not protrude through the whole bipolar plate 4 (see FIG. 5) or may be designed so that the support element 20 protrudes through the whole bipolar plate 4, (see FIG. 6). However, in both cases the height H_{VM} of the support element 20 as such does not protrude over the height H_{BPP} of the bipolar plate 4 at any location: H_{BPP}>H_{VM}.

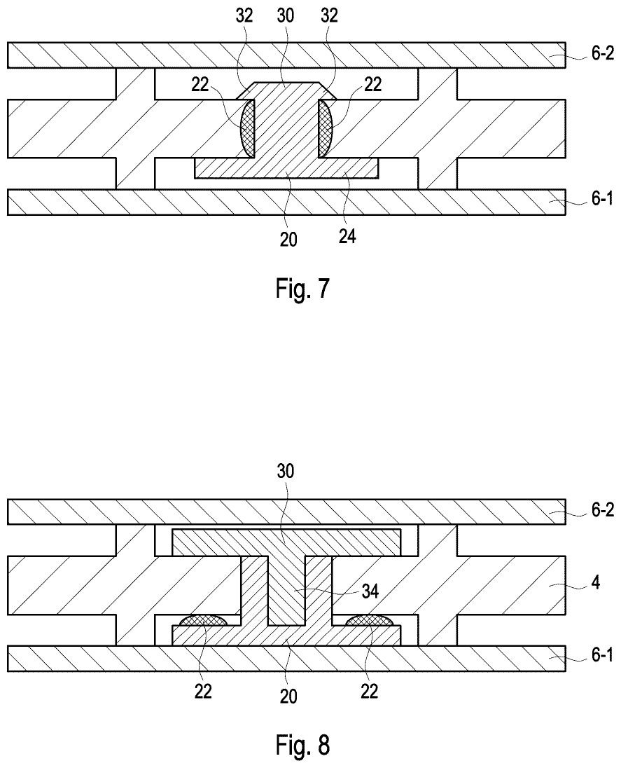

As can be seen in the embodiment illustrated in FIG. 7, the contact elements 22 may also be arranged at different locations than the step 28, e.g., at the side faces of the protruding portion 26, as illustrated. As can be further seen in FIG. 7 as well as in FIGS. 8 to 11, the support element 20 may be equipped with a cover portion 30. The cover portion 30 is designed to fix the support element 20 to the bipolar plate 4. This allows for a pre-mounting of the support element 20 before stacking of the fuel cell stack.

In the embodiment of FIG. 7, the cover portion 30 is an integral part of the support element 20 and may be designed as hooks 32 which are adapted to be snapped over a rim of the through hole 18, 19 of the bipolar plate 4. Alternatively, the cover portion 30 may be designed as separate element which may interact with the protruding portion 26 of the support element 20 as illustrated in FIGS. 8 to 10. Thereby the cover portion 30, as illustrated for example in FIG. 7 may be equipped with a connection section 34. In the illustrated embodiments the connection section 34 is designed as protrusion which may be accommodated within a recess (not illustrated) provided in the protruding portion 26 of the support element 20 for securely fixing the cover portion 30 to the protruding portion 26. Of course, other connection possibilities are likewise possible. E.g., the cover portion 30 may also be equipped with a recess which interacts with the protruding portion 26.

In all cases, it is preferred that, the cover portion 30 and the protruding portion 26 interact in such a way that the cover portion 30 and protruding portion 26 are fixed to each other, e.g., by force fit, friction fit etc. For that, further elements, like snapping elements, may be provided at the protruding portion 26 or at the cover portion 30. It is also possible that cover portion 30 and protruding portion 26 are bonded to each other e.g., by gluing or welding etc.

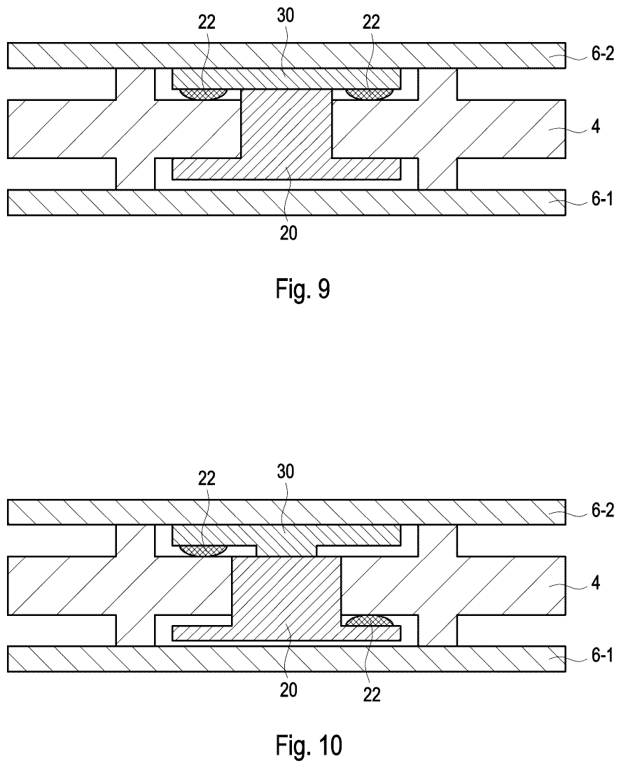

In case the support element 20 is provided with a cover portion 30, it is of course also possible to arrange the contact elements at the cover portion (see e.g., FIG. 9) or at both the cover portion 30 and the base portion 24 (see e.g., FIG. 910) or any other surface of the support element 20.

As mentioned above, each bipolar plate 4 of the exemplary embodiments of FIGS. 5 to 13 has at least one opening 18, 19 which is adapted to accommodate the protruding portion 26 of the support element 20. The support element 20 is adapted to be fixed to the bipolar plate 4. In a not illustrated embodiment, the support element 20 may also be adapted to be fixed to or be an integral part of the multilayer membrane electrode assembly 6 of the fuel cell stack 1, in particular may be part of a subgasket surrounding the multilayer membrane electrode assembly 6.

Besides its function as support element, the support element 20 may also be used as stacking and alignment assistance. For that, the support element may be equipped with structures which allow for an interaction of one support element 20-1 with an adjacent support element 20-2. FIGS. 11 to 13 illustrate various embodiments for a support element 20-1, 20-2 with additional alignment features.

As illustrated int FIGS. 11 to 13, in case such a stacking and alignment assistance shall be provided it is preferred that also the membrane electrode assembly 6 is provided with a through hole 40, through which a part or portion of the support element 20-1 may extend for an interaction with an adjacent support element 20-2.

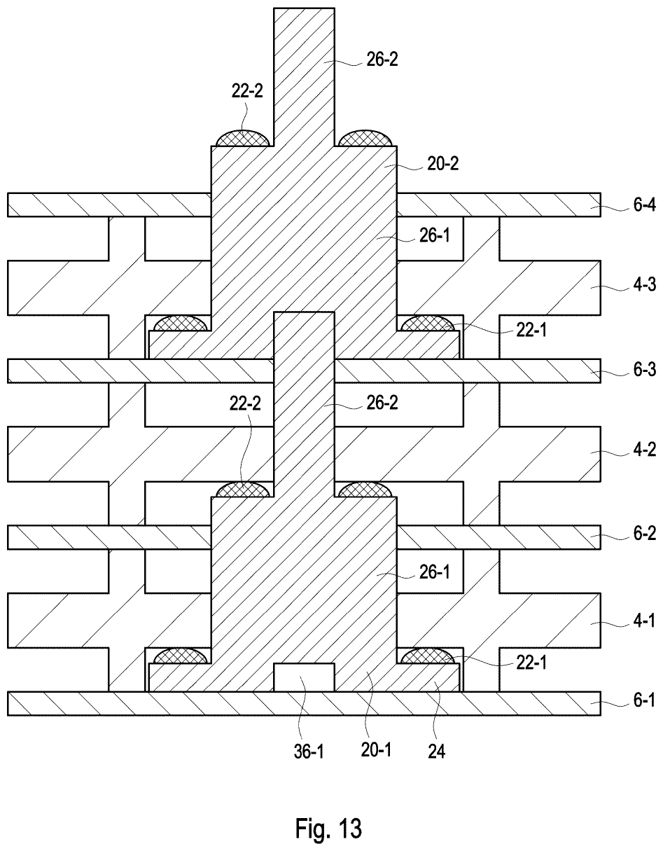

Further, for the interaction between two adjacent support elements 20-1, 20-2, and as illustrated in FIGS. 11 and 13, it is further preferred that the support element 20 is further equipped with a recess 36 at the opposite side of the protruding portion. Thereby it is further preferred that a size and/or shape and/or depth of the recess 36 is adapted to accommodate the protruding portion 26 of the adjacent support element. This allows for a stacking of the support elements 20-1 20-2 on top of each other which automatically results in an alignment of the bipolar plates 4 and the interlaying membrane electrode assemblies 6.

In FIG. 11, an embodiment is illustrated, wherein the cover portion 30 as described with reference to FIGS. 8 to 10 above, is at its membrane electrode assembly facing side equipped with a projecting portion 38, which extends through the through hole 40 provided at the membrane electrode assembly 6. This projection portion 38-1 is accommodated in the recess 36-2 of the adjacent support element 20-2, which allows for an alignment of bipolar plate 4-1 in relation to bipolar plate 4-2, as well as of the membrane electrode assemblies 6 to the bipolar plates 4.

The contact elements 22 of FIGS. 4 to 10 are all connected to corresponding signal path interrupting elements 42 (not shown in FIGS. 4 to 10). The signal path interrupting elements 42, and optionally also voltage fluctuation levelling elements 48, can either be arranged within the support elements 20, in which case wires from the signal path interrupting elements 42 are guided to the outside and to a signal line 44 (not shown), or can be arranged outside of the fuel cell stack 2, in which case wires from the contact elements 22 are guided to the outside and to corresponding signal path interrupting elements 42.

In FIG. 11, the signal path interrupting elements 42-1, 42-2 are arranged within the support elements 20-1, 20-2. Alternatively, the signal path interrupting elements 42-1, 42-2 may be arranged on a surface of the support elements 20-1, 20-2. The signal line 44 is guided within the fuel cell stack 2, in particular within the support elements 20-1, 20-2 from the signal path interrupting element 42-1 to the signal path interrupting element 42-2, across the bipolar plates 4-1, 4-2 and membrane electrode assemblies 6-2, 6-3. For this purpose, the support elements 20-1, 20-2 may be connected by pins 56 or the like. The pins 56 may be used for electrically connecting a wire, being the signal line 44, leading from the signal path interrupting element 42-1 to the signal path interrupting element 42-2 and further signal path interrupting elements (not shown) to the processing unit 46. The contact elements 22 are each connected via wires 58 to the corresponding signal path interrupting elements 42. Although not shown, also voltage fluctuation levelling elements 48 may be arranged together with the signal path interrupting elements 42 inside the support element 20.

Alternatively, the signal line 44 may be an optical fiber or may be an opening through the bipolar plates 4 and membrane electrode assemblies 6 for guiding light from the first signal path interrupting element 42-1 to the processing unit 46.

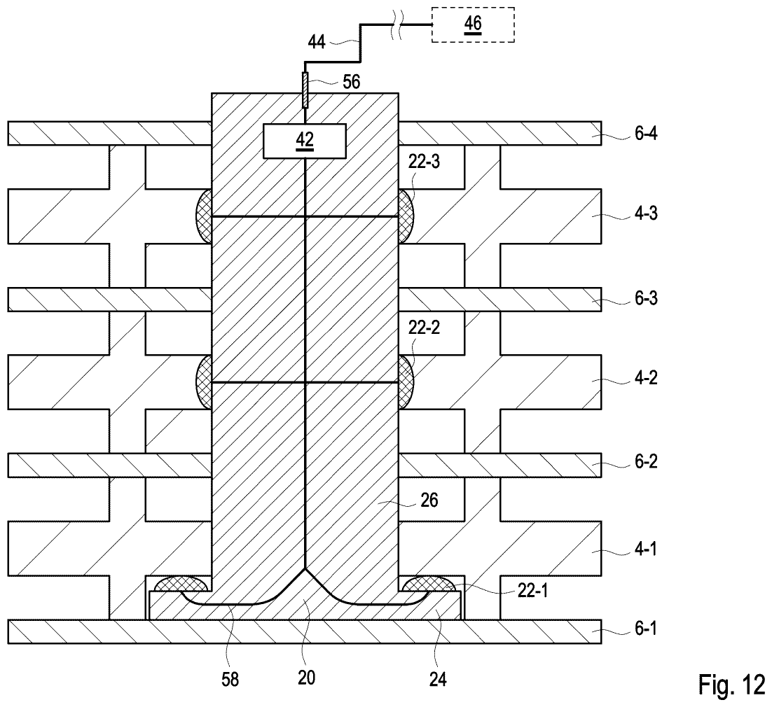

In the embodiments of FIGS. 12 and 13, the support element 20 extends over more than a single bipolar plate 4, in FIG. 12 over three bipolar plates 4-1, 4-2, 4-3, in FIG. 13 over two bipolar plates 4-1, 4-2.

As shown in FIG. 12, one support element 20 may be used for contacting several bipolar plates 4-1 to 4-3. In this embodiment, the voltages of three bipolar plates 4-1 to 4-3 are sensed and forwarded to one signal path interrupting element 42-1. Thus, instead of interrupting the signal line 44 based on the voltage of each bipolar plate 4-1, 4-2, 4-3 independently, the signal path interrupting element 42-1 interrupts (or forwards) the signal on the signal line 44 based on an accumulation of the voltages of a subgroup of the bipolar plates 4-1 to 4-3.

In FIG. 13, the protruding portion 26 of the support element 20 comprises a first part 26-1 and a second part 26-2, which are recessed to each other and form a further step 27. As can be further seen, the support element 22 has a first contact element 22-1 at the base step, and, at the further step 27, a second contact element 22-2, wherein the first contact element is adapted to contact the first bipolar plate 4-1 and the second contact element 22-2 is adapted to contact the second bipolar plate 4-2.

Further, each bipolar plate 4 has a first opening 18, 19 which is adapted to accommodate the first part 26-2 of the protruding portion 26 of the support element 20 and a second opening 19 which is adapted to accommodate the second part 26-2 of the protruding portion 26 of the support element 20. The first and second bipolar plates 4-1, 2-2 are arranged in such a way that the first opening 18, 19 of the first bipolar plate 4-1 is aligned with the second opening 19 of the second bipolar plate 4-2.

Further, as illustrated, the second part 26-1 of the protruding portion 26 may be accommodated in the recess 36-2 of the adjacent support element 20-2, which allows for the automatic alignment of the bipolar plate 4 and membrane electrode assemblies 6. It should be further noted that in this embodiment, the membrane electrode assembly 6 is also equipped with two through holes 40, 41 with different sizes. Thus, membrane electrode assembly 6-2 has a through hole 40, having a first size and membrane electrode assembly 6-3 has a through hole 41, which differ from the size of through hole 40. As with the through holes 18, 19 of the bipolar plate, the size and shape of the through holes may be adapted to the size and shape of the first and/or second part 26-1, 26-2 of the protruding portion 26.

It should be noted that even if the contact elements 22 are arranged at the steps it is also possible that the contact elements are arranged at other appropriate surfaces of the support element 20 or of the cover portion 30. Further, it should be noted that, although the several elements of the voltage monitoring unit 8 are only exemplary illustrated in FIGS. 11 and 12, they can be incorporated in all embodiments shown in the FIGS. 1 to 17.

In the embodiments described in FIGS. 14 to 17, the through holes 18, 19 of the bipolar plate 4 serve as first alignment through hole 19 and as second alignment through hole 19, wherein the first alignment through hole 18 is arranged at a different location than the second alignment through hole 19. In FIG. 14, the first alignment through hole 18 is diametrically opposite arranged to the second alignment through hole 19. Thereby, the first and second alignment through holes 18, 19 are symmetric concerning a rotation of 180° around a surface normal of the bipolar plate 4.

As further illustrated in FIG. 14, the first alignment through hole 18 has an elongated shape, whereas the second alignment through hole 19 has a circular shape. Thus, both alignment through holes differ in shape and size. However, it would be also possible that the first and the second alignment through holes 18, 19 have both elongated shapes, wherein a longitudinal axis of the first alignment through hole 18 may be perpendicular to the longitudinal axis of the second alignment through hole 19.

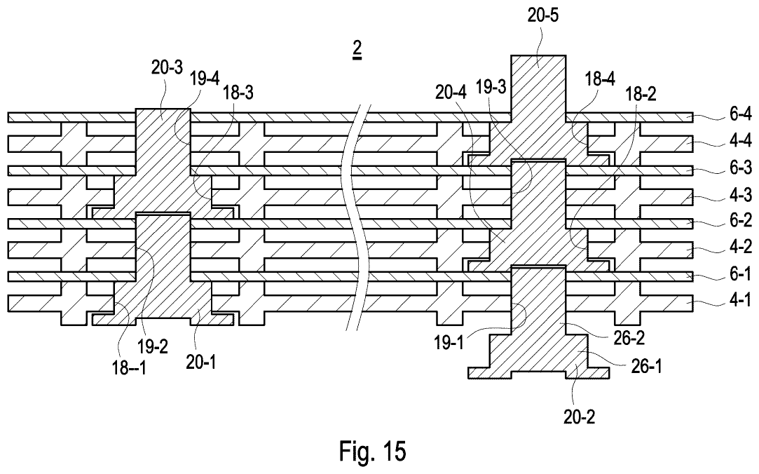

FIGS. 15 to 17 each show a schematic cross section along a line II-II of FIG. 14 through the alignment through holes 19, 18. Additionally, the embodiments of the fuel cell stack 2 illustrated in FIGS. 15 to 17 show a special stacking order for the bipolar plate and membrane electrode assemblies. In that, every second bipolar plate 4-2, 4-4 . . . is rotated by 180° compared to bipolar plates 4-1, 4-3 . . . , so that the first alignment through holes 18-1, 18-3 . . . of the first bipolar plates 4-1, 4-3 . . . are aligned with the second alignment through hole 19-2, 19-4 . . . of the second bipolar plates 4-2, 4-4 . . . . The same may apply for the membrane electrode assemblies 6 and their through holes 40, 41.

As can also be seen in FIGS. 15 to 17, the overall height H_{VM} of the support element 20 is designed to be at least equal to or greater than two cell pitches d=H_{MEA}+H_{BPP}, wherein one cell pitch is defined as the distance between two unit fuel cells, wherein each unit fuel cell consists of or comprises a bipolar plate 4 and a membrane electrode assembly 6: H_{VM}≥2*(H_{MEA}+H_{BPP}).

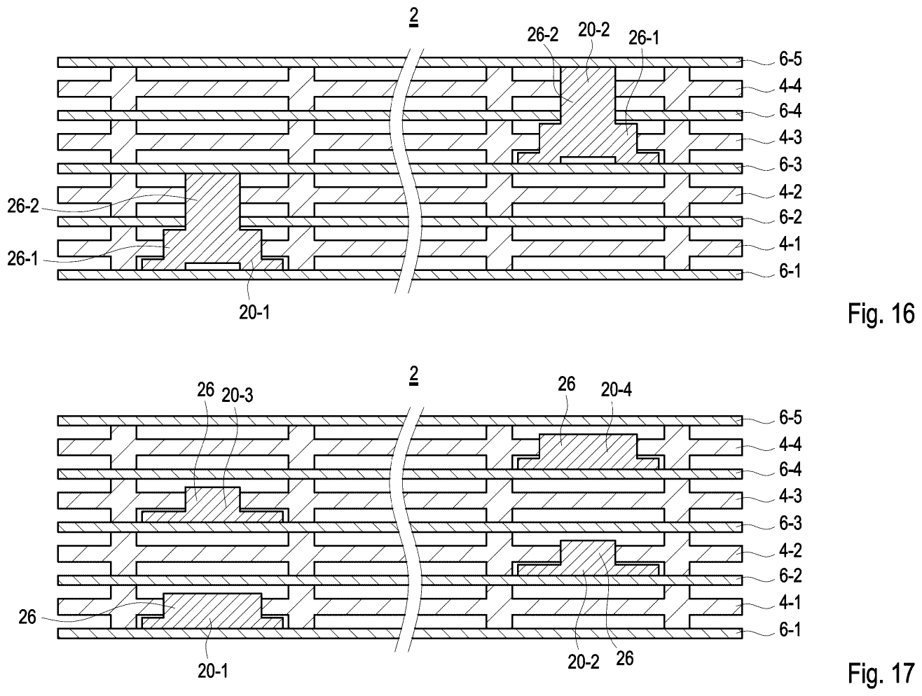

In the illustrated embodiments of FIGS. 15 and 16, the heights hₐ₁, hₐ₂ of the protruding portions 26-1, 26-2 are differently designed. The height hₐ₁ of the first protruding portion 26-1 resembles one cell pitch (hₐ₁≈H_{BPP}+H_{MEA}), whereas the height hₐ₂ of the second protruding portion 26-2 is greater than one cell pitch (h_{b2}>H_{BPP}+H_{MEA}). In this embodiment, it is preferred that also the membrane electrode assembly 6 is equipped with first and second alignment through holes 40, 42, which differ in size and shape.

As can be seen in FIGS. 15 to 17, the size of the first protruding portion 26-1 may resemble the size of the first alignment through hole 18 of the bipolar plate 4 and the size of the second protruding portion 26-2 may resemble the size of the second alignment through hole 19 of the bipolar plate 4. The same applies to the membrane electrode assemblies 6 and their through holes 40, 41.

Further with reference to FIG. 15, the support elements 2 are alternatingly arranged at the bipolar plates 4. That means, at bipolar plate 4-1, a first support element 20-1 is arranged at the first alignment through hole 18-1 of the first bipolar plate 4-1, so that the base plate 24 contacts the first bipolar plate 4-1 and the first protruding portion 26-1 of the first support element 20-1 extends through the first alignment hole 18-1. In the second alignment through hole 19-1 of the first bipolar plate 4-1 in turn, a second support element 20-2 is arranged in such a way that its second protruding portion 26-2 extends through the second alignment through hole 19-1 of the first bipolar plate 4-1.

At the adjacent bipolar plate 4-2, the situation is the same, but the alignment through holes 18-2, 19-2 are vice versa, as the bipolar plate 4-2 is rotated by 180°. Thus, the second protruding portion 26-2 of the first support element 20-1 extends through the corresponding second alignment through hole 19-2 of the second bipolar plate 4-2, whereas at the first alignment through hole 16-2 of the second bipolar plate 4-2, the base plate 24 of a third support element 20-3 is arranged, and its first protruding portion 26-2 extends through the first alignment through hole 16-2 of the second bipolar plate 4-2.

For the third bipolar plate 4-3 or in general for the 2n−1 bipolar plate in the stack, the situation is the same as for the first bipolar plate and for the fourth bipolar plate 4-4 or in general the 2n bipolar plate the situation is the same as for the second bipolar plate 4-2.

In contrast to FIG. 15, in the arrangement of FIG. 16, the first support element 20-1 contacts the first and the second bipolar plate 4-1, 4-2, whereas the second support element 20-2 contacts the third and fourth bipolar plate 4-3, 4-4. In an alternative arrangement as shown in FIG. 17, the first support element 20-1 contacts the first bipolar plate 4-1, the second support element 20-2 contacts the second bipolar plate 4-2, the third support element 20-3 contacts the first bipolar plate 4-3, and the fourth support element 20-4 contacts the fourth bipolar plate 4-4. As can be seen in FIG. 17, the support elements 20-1, 20-4 as well as 20-2, 20-3 differ in size for allowing an alignment of the bipolar plates 4.

By contacting the bipolar plates 4 alternatingly, the space required in the fuel cell stack 2 may be reduced, allowing for more space for accommodating further elements, for example the signal path interrupting element and the like.

It should be noted that, although not shown in FIGS. 15 to 17, each support element 20 comprises contact elements 22, and may comprise the further elements, i.e., signal path interrupting element etc., as described with reference to FIGS. 4 to 13.

In summary, the disclosed support clement allows for simple and reliable arrangement of the support elements at the bipolar plates. Further, any misplacement of the electric contacting element can be avoided, whereby also any damage of the fuel cell stack due to the misplacement may be avoided.

1. Voltage monitoring arrangement for an electric cell stack comprising a plurality of electric plates sandwiching insulation layers,
wherein the voltage monitoring arrangement is configured to monitor a voltage of at least one electric plate of the electric cell stack,
at least one voltage monitoring unit with a contact element being in contact with the at least one electric plate,
a first signal line being configured to supply a first signal from a signal source to a processing unit,
wherein the voltage monitoring unit comprises a first signal path interrupting element interposed in the first signal line,
wherein the first signal path interrupting element is connected to the contact element and is configured to forward the first signal dependent on a voltage being present at the at least one electric plate,
a support element designed to be arranged within the electric cell stack, wherein the support element is configured to support at least the contact element.

2. Voltage monitoring arrangement according to claim 1, wherein the support element is made from an electrically insulating material and wherein the contact element is made from an electrically conducting material.

3. Voltage monitoring arrangement according to claim 1, wherein the support element is equipped with the voltage monitoring unit.

4. Voltage monitoring arrangement according to claim 1, wherein the support element is configured to be arranged at and/or in a through hole which is provided in at least one of the electric plates.

5. Voltage monitoring arrangement according to claim 1, wherein the support element has a base plate and a protruding portion, wherein the protruding portion is recessed from the base plate portion so that a step is formed between the base plate and the protruding portion, particularly wherein the support element is adapted to be stacked on a further support element, particularly, wherein the support element has, at the opposite side of the protruding portion, at the base plate a recess, which is dimensioned to accommodate the protruding portion of an adjacent support element, so that one support element is adapted to be stacked on a further support element.

6. Voltage monitoring arrangement according to claim 1, wherein the support element comprises through holes being configured to accommodate cables and/or to transmit light.

7. Voltage monitoring arrangement according to claim 5, wherein the contact element is arranged at the base plate such that the contact element is in contact with the electric plate.

8. Voltage monitoring arrangement according to claim 1, wherein the first signal path interrupting element is arranged at or within the support element, particularly wherein the first signal line is arranged within the support element.

9. Voltage monitoring arrangement according to claim 1, wherein the voltage monitoring unit comprises a voltage fluctuation levelling element being arranged between the contact element and the first signal path interrupting element and being configured to transmit the voltage from the contact element to the first signal path interrupting element when the voltage is above a levelling threshold voltage, particularly wherein the voltage fluctuation levelling element is arranged at and/or within the support element.

10. Voltage monitoring arrangement according to claim 1, wherein the voltage monitoring arrangement comprises a plurality of voltage monitoring units each comprising a contact element being in contact with a respective one of the plurality of electric plates and wherein the voltage monitoring arrangement comprises a plurality of support elements, each supporting at least one contact element.

11. Voltage monitoring arrangement according to claim 10, wherein each voltage monitoring unit comprises a first signal path interrupting element interposed in the first signal line, wherein the respective first signal path interrupting element is connected to the corresponding contact element and is configured to forward the first signal dependent on a voltage being present at the respective electric plate, wherein the first signal path interrupting elements of the plurality of voltage monitoring units are connected in series.

12. Voltage monitoring arrangement according to claim 10, wherein a subgroup of the voltage monitoring units comprises a first signal path interrupting element interposed in the first signal line, wherein each of the first signal path interrupting elements is connected to a plurality of corresponding contact elements and is configured to forward the first signal dependent on a voltage being present at the respective electric plates being contacted by the corresponding plurality of contact elements, wherein the first signal path interrupting elements of the plurality of voltage monitoring units are connected in series.

13. Voltage monitoring arrangement according to claim 10, wherein two support elements supporting contact elements, which contact two adjacent electric plates, are arranged at different ends of the electric cell stack.

14. Voltage monitoring arrangement according to claim 1, wherein the voltage monitoring arrangement comprises a second signal line being connected in parallel with the first signal line and wherein the voltage monitoring unit comprises a second signal path interrupting element, which is interposed in the second signal line and is connected in parallel with the first signal path interrupting element, wherein the first signal path interrupting element is configured to forward or to interrupt the first signal when the voltage at the at least one electric plate is above a first reference threshold voltage and wherein the second signal path interrupting element is configured to forward or to interrupt the second signal when the voltage at the at least one electric plate is above a second reference threshold voltage.
